(19) United States
(12) Patent Application Publication
(10) Pub. No.: US 2015/0177985 A1
(43) Pub. Date: Jun. 25, 2015

(54) INFORMATION PROCESSING DEVICE

(71) Applicant: KABUSHIKI KAISHA TOSHIBA, Minato-ku (JP)

(72) Inventors: Nobuhiro Kondo, Yokohama (JP); Kenichi Maeda, Kamakura (JP)

(73) Assignee: KABUSHIKI KAISHA TOSHIBA, Minato-ku (JP)

(21) Appl. No.: 14/636,765

(22) Filed: Mar. 3, 2015

Related U.S. Application Data
(63) Continuation of application No. PCT/JP2013/056885, filed on Mar. 6, 2013.

(30) Foreign Application Priority Data
Sep. 7, 2012 (JP) 2012-197829

(51) Int. Cl. G06F 3/06; H04N 1/21; G06T 1/60

(52) U.S. Cl. CPC G06F 3/0605; G06T 1/60; H04N 1/2129; G06F 3/0679; G06F 3/0635; G06F 3/0659; G06F 2206/1014

(57) ABSTRACT

According to one embodiment, an information processing device includes: a host device, a semiconductor memory device with a nonvolatile semiconductor memory, and a communication path connecting the host device and the semiconductor memory device together.

### CROSS-REFERENCE TO RELATED APPLICATIONS

This application is a Continuation application of PCT Application No. PCT/JP2013/056885, filed Mar. 6, 2013 and based upon and claiming the benefit of priority from Japanese Patent Application No. 2012-197829, filed Sep. 7, 2012, the entire contents of all of which are incorporated herein by reference.

### FIELD

Embodiments of the present invention relate to an information processing device.

### BACKGROUND

UMA (Unified Memory Architecture) is a technique using a GPU (Graphical Processing Unit) or the like comprising a plurality of arithmetic processors integrated together and sharing one memory.

### BRIEF DESCRIPTION OF THE DRAWINGS

FIG. 1 is a diagram showing an example of a configuration of an information processing device according to a first embodiment;

FIG. 2 is a diagram showing a memory structure in a device use area according to the first embodiment;

FIG. 3 is a diagram illustrating a memory structure in an L2P cache tag area according to the first embodiment;

FIG. 4 is a diagram illustrating a memory structure in an L2P cache area according to the first embodiment;

FIG. 5 is a diagram illustrating a memory structure in a write cache tag area according to the first embodiment;

FIG. 6 is a diagram illustrating a memory structure in a write cache area according to the first embodiment;

FIG. 7 is a diagram illustrating an example of the data structure of a write command according to the first embodiment;

FIG. 8 is a diagram showing an example of a format of a data transfer command according to the first embodiment;

FIG. 9 is a diagram showing an example of flags contained in the data transfer command according to the first embodiment;

FIG. 10A is a diagram showing an operation of a memory system receiving data via a third port, and FIG. 10B is a diagram showing an operation of the memory system receiving data via a second port;

FIG. 11A is a diagram showing an operation of the memory system transmitting data via the third port, and FIG. 11B is a diagram showing an operation of the memory system transmitting data via the second port;

FIG. 12 is a flowchart illustrating the operation of a device controller main section;

FIG. 13 is a flowchart illustrating the operation of the device controller main section;

FIG. 14 is a flowchart illustrating a process in which the device controller main section refers to the L2P cache area;

FIG. 15 is a flowchart illustrating a process in which the device controller main section writes a physical address to the L2P cache area;

FIG. 16 is a flowchart illustrating a process in which the device controller main section refers to the L2P cache area;

FIG. 17 is a flowchart illustrating a process in which the device controller main section reads an entry in the L2P cache area;

FIG. 18 is a flowchart illustrating a process in which the device controller main section acquires write data from a host device;

FIG. 19 is a flowchart illustrating a process in which the device controller main section manipulates the value of a DB bit;

FIG. 20 is a flowchart illustrating a process in which the device controller main section manipulates the value of a VL bit; and

FIG. 21 is a flowchart illustrating a process in which the device controller main section determines a priority.

FIG. 22 is a table which defines the relations between programs and priorities;

FIG. 23 is a flowchart illustrating a process in which a host notifies a device of a priority;

FIG. 24 is a diagram schematically showing a basic configuration of an information processing device according to a fifth embodiment;

FIG. 25 is a flowchart illustrating a process in which the host determines whether or not a camera as the device has been connected to the host;

FIG. 26 is a flowchart illustrating a process in which the device controller main section determines the priority;

FIG. 27 is a diagram schematically showing a basic configuration of an information processing device according to a sixth embodiment; and

FIG. 28 is a flowchart illustrating a process in which the device controller main section determines the priority.

### DETAILED DESCRIPTION

In general, according to one embodiment, an information processing device includes:

a host device, a semiconductor memory device with a nonvolatile semiconductor memory, and a communication path connecting the host device and the semiconductor memory device together,

the host device includes:

a first storage section; and

a first control section to which the first storage section and the communication path are connected and which controls the first storage section,

the communication path includes:

a plurality of ports to each of which a priority is assigned, and

the semiconductor memory device is connected to the communication path to transmit a first command containing a first flag which determines the priority of the port based on a priority of a type of data transmitted to and from the first storage section.

Embodiments will be described below with reference to the drawings. In the following description, components with substantially the same functions and configurations are denoted by the same reference numerals. The technical concepts of the embodiments do not limit the materials, shapes, structures, arrangements, and the like of components of the embodiments to the materials, shapes, structures, arrangements, and the like described below. The technical concepts of the embodiments may be varied within the scope of the claims.

### First Embodiment

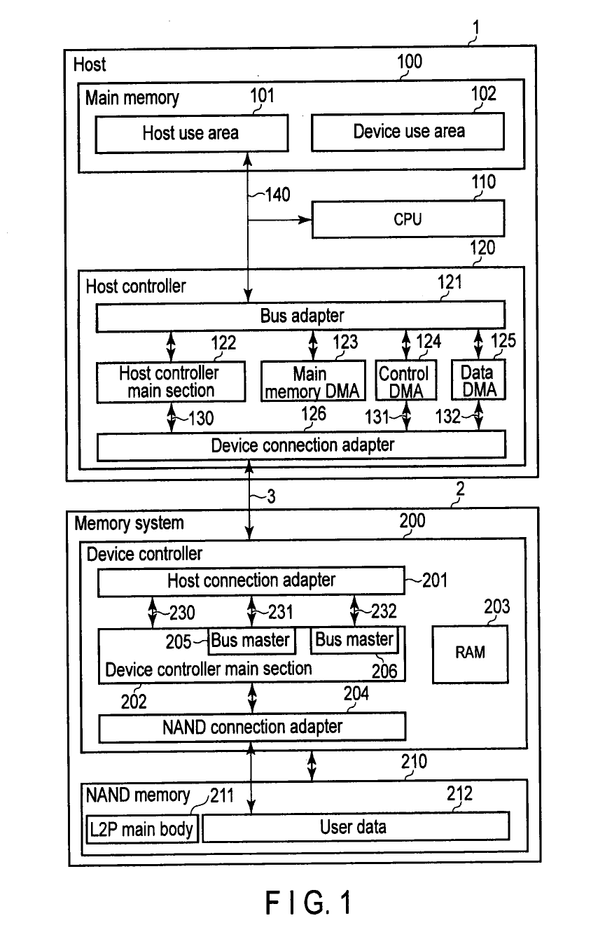

FIG. 1 schematically shows a basic configuration of an information processing device according to the present embodiment. The information processing device according to the present embodiment includes a host device (or an external device) 1 and a memory system 2 which functions as a memory device for the host device 1. The host device 1 and the memory system 2 are connected together via a communication path 3. A flash memory for embedding applications which conforms to the Universal Flash Storage (UFS) standard or a solid-state drive (SSD) is applicable to the memory system 2. The information processing device is, for example, a personal computer, cellular phone, or an image pickup device. As a communication standard for the communication path 3, for example, the Mobile Industry Processor Interface (MIPI) UniPro protocol has been adopted.

<Summary of the Memory System>

The memory system 2 includes a NAND flash memory 210 serving as a nonvolatile semiconductor memory and a device controller 200 which transfers data to and from the host device 1.

The NAND flash memory 210 is formed of at least one memory chip with a memory cell array. The memory cell array is formed of a plurality of memory cells arranged in a matrix. Moreover, each block is formed of a plurality of pages. Each of the pages is a unit of write and read.

Furthermore, the NAND memory 210 stores an L2P table 211 and user data 212 transmitted by the host device 1. The user data 212 includes, for example, an operating system program (OS) for which the host device 1 provides a runtime environment, a user program executed on an OS by the host device 1, and data input and output by the OS or a user program.

The L2P table 211 is a type of management information required to allow the memory system 2 to function as an external storage device for the host device 1 and is address translation information which associates a logical block address (LBA) used by the host device 1 to access the memory system 2 with a physical address (block address+page address+intra-page storage position) in the NAND memory 210. A part of the L2P table 211 is cached in an L2P cache area 300 in the host device 1 described below. To be distinguished from content cached in the L2P cache area 300, the L2P table 211 stores in the NAND memory 210 is hereinafter referred to as an L2P main body 211.

The device controller 200 includes a host connection adapter 201 which is a connection interface for the communication path 3, a NAND connection adapter 204 which is a connection interface between the device controller 200 and the NAND memory 210, a device controller main section 202 which controls the device controller 200, and a RAM 203.

The RAM 203 is used as a buffer configured to store data to be written to the NAND memory 210 or data read from the NAND memory 210. Furthermore, the RAM 203 is used as a command queue which queues commands related to write requests and read requests input by the host device 1. For example, the RAM 203 can be formed of a small-scale SRAM, a small-scale DRAM, or the like. Additionally, the functions of the RAM 203 may be provided by registers or the like instead of the RAM 203.

The device controller main section 202 controls data transfers between the host device 1 and the RAM 203 via the host connection adapter 201. The device controller main section 202 controls data transfers between the RAM 203 and the NAND memory 210 via the NAND connection adapter 204. In particular, the device controller main section 202 functions as a bus master in the communication path 3 between the device controller main section 202 and the host device 1 to transfer data using a first port 230. The device controller main section 202 further includes two other bus masters 205 and 206. A bus master 205 can transfer data to and from the host device 1 using a second port 231. A bus master 206 can transfer data to and from the host device 1 using a third port 232. The roles of ports 230 to 232 will be described below.

The device controller main section 202 includes, for example, a microcomputer unit with an arithmetic device and a storage device. The arithmetic device executes firmware pre-stored in the storage device to implement the functions of the device controller main section 202. The storage device may be omitted from the device controller main section 202, with the firmware stored in the NAND memory 210. Additionally, the device controller main section 202 may be configured using an ASIC.

Furthermore, the memory system 2 according to the present embodiment assumes a flash memory embedded in the information processing device conforming to the Universal Flash Storage (UFS) standard. Thus, commands and the like described conform to the UFS standard.

<Summary of the Host Device>

The host device 1 includes a CPU 110 which executes an OS and user programs, a main memory 100, and a host controller 120. The main memory 100, the CPU 110, and the host controller 120 are connected together by a bus 140.

The main memory 100 is configured using, for example, a DRAM. The main memory 100 includes a host use area 101 and a device use area 102. The host use area 101 is used as a program decompression area when the host device 1 executes an OS and user programs or as a work area when the host device 1 executes a program decompressed into the program decompression area. The device use area 102 is used as a cache area in which management information on the memory system 2 is cached and on which read and write operations are performed. Here, the L2P table 211 is taken as an example of management information cached in the memory system 2. Furthermore, write data is intended to be cached in the device use area 102.

<Summary of Ports>

Now, ports of the host device 1 and the memory system 2 according to the present embodiment will be described. The host device 1 and the memory system 2 according to the present embodiment are physically connected together by one line (communication path 3). However, the host device 1 and the memory system 2 are connected together by a plurality of access points described below and referred to as ports (also referred to as CPorts).

The host controller 120 includes a bus adapter 121 which is a connection interface for the bus 140, a device connection adapter 126 which is a connection interface for the communication path 3, and a host controller main section 122 which transfers data and commands to and from the main memory 100 and the CPU 110 via the bus adapter and which transfers data (including commands) to and from the memory system 2 via the device connection adapter 126. The host controller main section 122 is connected to the device connection adapter 126 by a first port 130. The host controller main section 122 can transfer data to and from the memory system 2 via the first port 130.

Furthermore, the host controller 120 includes a main memory DMA 123 which carries out DMA transfer between the host use area 101 and the device use area 102, a control DMA 124 which captures commands transmitted by the memory system 2 to access the device use area 102 and which transmits, to the memory system, status information indicative of how the host controller main section 122 is dealing with the device use area 102, a data DMA 125 which carries out DMA transfer between the device use area 102 and the memory system 2. The control DMA 124 is connected to the device connection adapter 126 by a second port 131. The control DMA 124 can transmit and receive commands and status information to and from the memory system 2 via the second port 131. Additionally, the data DMA 125 is connected between the device connection adapter 126 by a third port 132. The data DMA 125 can transmit and receive data to and from the memory system 2 via the third port 132.

The functions of the device connection adapter 126 and the host connection adapter 201 allow the first port 130, the second port 131, and the third port 132 to be associated with the first port 230, the second port 231, and the third port 232, respectively. Specifically, the device connection adapter 126 transmits content sent to the memory system 2 via the first port 130 to the device controller main section 202 via the first port 230. The device connection adapter 126 also transmits content sent to the memory system 2 via the second port 131 to the device controller main section 202 via the second port 231. The device connection adapter 126 further transmits content sent to the memory system 2 via the third port 132 to the device controller main section 202 via the third port 232.

Furthermore, the device connection adapter 126 transmits content sent to the host device 1 via the first port 230 to the host controller main section 122 via the first port 130. The device connection adapter 126 also transmits content sent to the host device 1 via the second port 231 to the control DMA 124 via the second port 131. The device connection adapter 126 further transmits content sent to the host device 1 via the third port 232 to the data DMA 125 via the third port 132. The content transmitted to the control DMA 124 and the data DMA 125 is, for example, transmitted to the host controller main section 122 via the bus adapter 121.

Each of ports 130 to 132 may include an input buffer which is used for communication with the memory system 2. The host controller main section 122, the control DMA 124, and the data DMA 125 are connected to the memory system 2 using separate input/output buffers. Thus, the host controller 120 can independently carry out communication with the memory system 2 using the host controller main section 122, communication with the memory system 2 using the control DMA 124, and communication with the memory system 2 using the data DMA 125. Furthermore, these communications can be switched to one another without the need to change the input/output buffers. Thus, the switching of the communication can be achieved quickly. This also applies to ports 230 to 232 provided in the memory system 2.

As described above, the information processing device according to the present embodiment includes the three types of ports, the first ports (also referred to as CPort 0) 130 and 230, the second ports (also referred to as CPort 1;) 131 and 231, and the third ports (also referred to as CPort 2) 132 and 232.

Furthermore, a priority (traffic class, also referred to as TC or the like) is set for each of the ports. Specifically, priority 0 (low) is set for the first ports 130 and 230. Priority 1 (high) is set for the second ports 131 and 231. Priority 0 (low) is set for the third ports 132 and 232.

The first ports 130 and 230 are basically used when the host device 1 makes a request to the memory system 2. Either the second ports 131 and 231 or the third ports 132 and 232 are selected as appropriate by such a request from the memory system 2 as described below.

If the first ports 130 and 230 are not distinguished from each other, the first ports 130 and 230 are collectively referred to as the first port for simplification. Furthermore, if the second ports 131 and 231 are not distinguished from each other, the second ports 131 and 231 are collectively referred to as the second port for simplification. Moreover, if the third ports 132 and 232 are not distinguished from each other, the third ports 132 and 232 are collectively referred to as the third port for simplification.

<Priority (Traffic Class [TC])>

Now, the priority (traffic class [TC]) will be described. The priority (traffic class) is a preferential order used when the host device 1 transmits data or the like to the memory system 2. Specifically, the priority is a value indicating the order of data transfers or the like between the host device 1 and the memory system 2 when the data transfers contend against one another. The first embodiment sets, by way of example, two types of priorities, priority 1 (also referred to as TC1) and priority 0 (also referred to as TC0) which is lower than priority 1.

The priority is pre-set for each of the first to third ports. According to the present embodiment, the first port (CPort 0) is set to priority 0 (TC 0), the second port (CPort 1) is set to priority 1 (high) (TC 1), and the third port (CPort 2) is set to priority 0 (low) (TC 0). A method for selecting the priority will be described below.

<Summary of the Device Use Area>

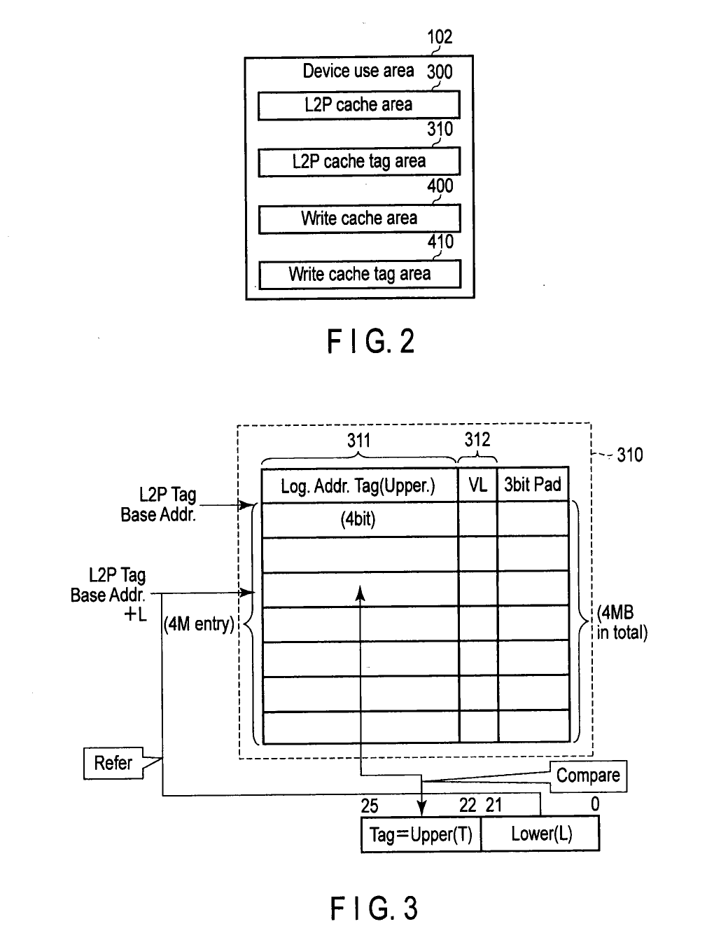

FIG. 2 is a diagram illustrating the memory structure of the device use area 102. As shown in FIG. 2, the device use area 102 includes an L2P cache area 300 in which a part of the L2P main body 211 is cached, an L2P cache tag area 310 in which tag information used for hit or miss determination for the L2P cache area 300 is stored, a write cache area 400 which is a memory area of a cache structure in which write data is cached, and a write cache tag area 410 in which tag information used for hit or miss determination for the write cache area 400 is stored.

<Memory Structure of the L2P Cache Tag Area>

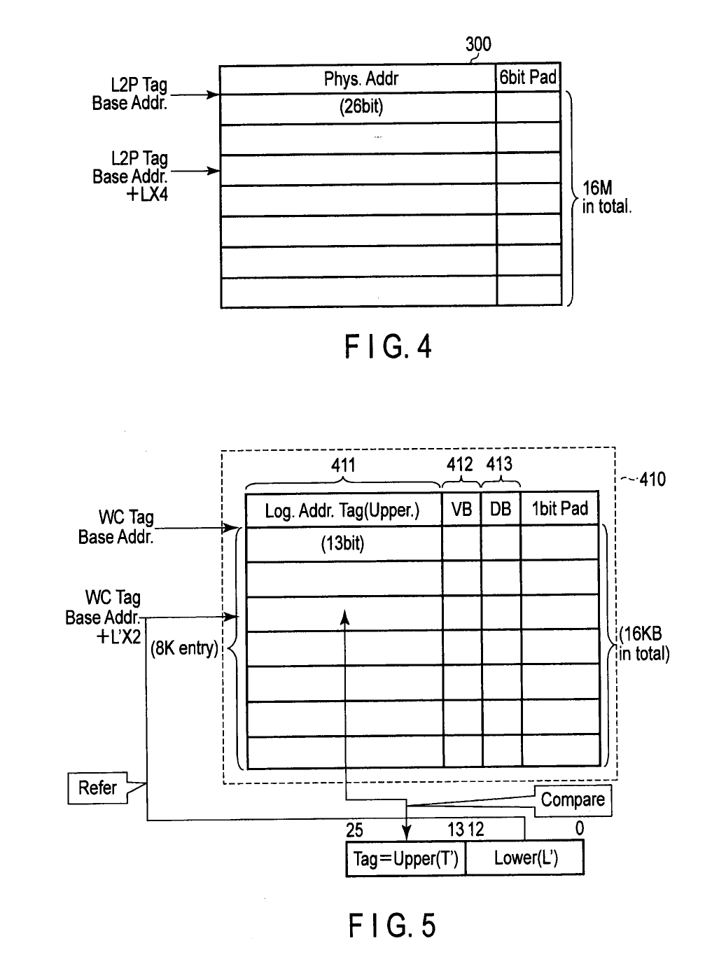

FIG. 3 is a diagram illustrating the memory structure of the L2P cache tag area 310. FIG. 4 is a diagram illustrating the memory structure of the L2P cache area 300. Here, by way of example, the LBA has a data length of 26 bits, and the L2P cache area 300 is intended to be referred to using the lower 22 bits of the LBA. In the description, the upper 4 bits of the LBA are represented as T, and the lower 22 bits of the LBA are represented as L. The LBA is intended to be assigned to each page forming the NAND memory 210 (here, the page is equivalent to 4 Kbytes).

Each of the cache lines forming the L2P cache area 300 stores a physical address (Phys. Addr.) for one LBA as shown in FIG. 4. The L2P cache area 300 includes 2²² cache lines. Each of the cache lines has a capacity of 4 bytes equivalent to a sufficient size to store 26 bits of physical address. Thus, the L2P cache area 300 has a total size of 2²²×4 bytes, that is, 16 Mbytes. Furthermore, the L2P cache area 300 is configured such that physical addresses corresponding to the LBA are stored in the L2P cache area 300 in order of the value of L. That is, the individual cache lines forming the L2P cache area 300 are read by referring to addresses each obtained by adding the page address of the L2P cache area 300 (L2P Base Addr.) to 4*L. An excess area in each of the 4-byte cache lines forming the L2P cache area 300, that is, the entire area of the 4-byte cache line except for the area in which the 26-bit physical address is stored, is represented as “Pad”. In the following tables, excess portions are represented as “Pad”.

Furthermore, as shown in FIG. 3, the value T serving as tag information is recorded in the L2P cache tag area 310 in order of the value of L for each of the cache lines stored in the L2P cache area 300. Each of the entries includes a field 311 in which tag information is stored and a field 312 in which a. VL (Valid L2p) bit indicative of whether or not the cache line is valid is stored. Here, the L2P cache tag area 310 is configured such that T recorded in the L2P cache tag area 310 as tag information matches the upper digits T of the LBA corresponding to the physical address stored in the corresponding cache line (that is, the cache line referred to using L) in the L2P cache area 300. That is, whether or not the physical address corresponding to the upper digits T of the desired LBA is cached in the L2P cache area 300 is determined by referring to an address obtained by adding the base address of the L2P cache tag area 310 to the value of L forming the desired LBA, to determine whether or not the tag information stored in the referred-to position matches the value of T forming the desired LBA. If the tag information and the value of T match, the information processing device determines that the physical address corresponding to the desired LBA is cached. If the tag information and the value of T fail to match, the information processing device determines that the physical address corresponding to the desired LBA is not cached. T is a 4-bit value, and a VL bit has a capacity of 1 bit. Thus, each entry has a capacity of 1 byte. Therefore, the L2P cache tag area 310 has a size of 2²² multiplied by 1 byte, that is, a size of 4 Mbytes.

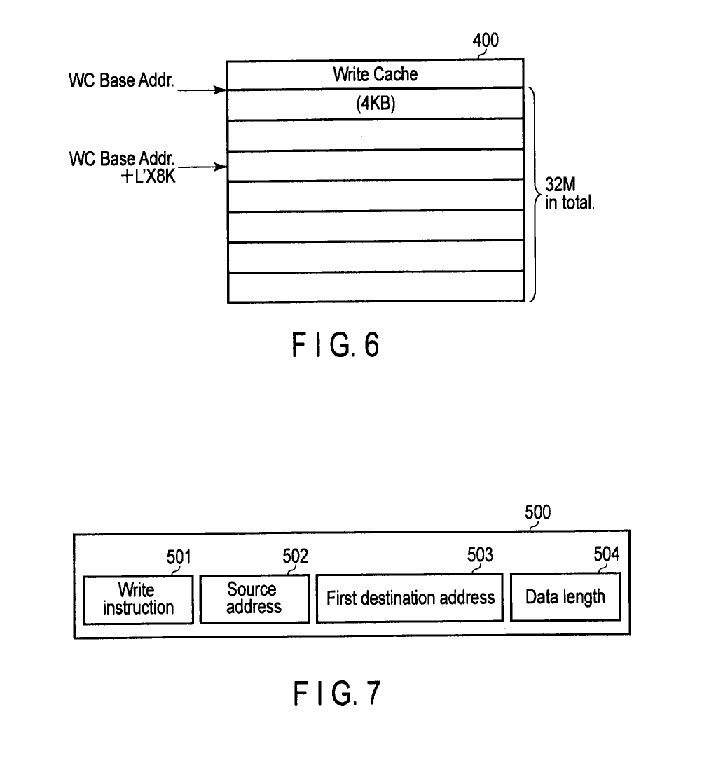

FIG. 5 is a diagram illustrating the memory structure of the write cache tag area 410. FIG. 6 is a diagram illustrating the memory structure of the write cache area 400. Here, the write cache area 400 is referred to using the value of the lower 13 bits of the LBA. In the following description, the value of the upper 13 bits of the LBA is represented as T′. The value of the lower 13 bits is represented as L′.

Write data of a page size is stored in the individual cache lines forming the write cache area 400, as shown in FIG. 6.

The write cache area 400 includes 2¹³ cache lines. Write data of a page size (here, 4 Kbytes) is cached in this cache line. Thus, the write cache area 300 has a total size of 2¹³×4 Kbytes, that is, 32 Mbytes.

Furthermore, in the write cache area 400, the corresponding write data is stored in order of the value of L′. That is, the individual cache lines forming the write cache area 400 are read by referring to addresses each obtained by adding the page address of the write cache area 400 (WC Base Addr.) to L′*8K.

Additionally, as shown in FIG. 5, T′ serving as tag information is recorded in the write cache tag area 410 in order of L′ for each of the cache lines stored in the write cache area 400. Each of the entries includes a field 411 in which tag information is stored, a field 412 in which a valid buffer (VB) bit indicative of whether or not the cache line is valid is stored, and a field 413 in which a dirty buffer (DB) bit indicative of whether the cached write data is dirty or clean.

The write cache tag area 410 is configured such that T′ recorded in the write cache tag area 410 as tag information matches the upper digits T′ of the LBA assigned to a page in which the write data stored in the corresponding cache line (that is, the cache line referred to using L′) in the write cache area 400 is to be stored. That is, whether or not the write data corresponding to the desired LBA is cached in the write cache area 400 is determined by referring to an address obtained by adding the base address of the write cache tag area 410 (WC Tag Base Addr.) to the value of L′ forming the upper digits T of the desired LBA, to determine whether or not the tag information stored in the referred-to position matches the value of T′ forming the desired LBA.

A dirty cache line refers to a state in which the write data stored in the cache line fails to match the data stored at the corresponding address on the NAND memory 210. A clean cache line refers to a state in which the write data and the stored data match. A dirty cache line is cleaned by being written back to the NAND memory 210. Each piece of tag information T′ in the write cache tag area 410 has a data length of 13 bits, and each of the DB bit and the VB bit requires a size of 1 bit. Thus, each entry has a capacity of 2 bytes. Therefore, the write cache tag area 410 has a size of 2¹³ multiplied by 2 bytes, that is, a size of 16 Kbytes.

The CPU 110 executes the OS and user programs, and based on a request from any of these programs, generates a write command to write data stored in the host use area 101 to the memory system 2. The generated write command is transmitted to the host controller 120.

<Summary of the Data Structure of a Write Command>

FIG. 7 is a diagram illustrating an example of the data structure of a write command. As shown in FIG. 7, a write command 500 includes a write instruction 501 indicating that the command 500 is intended to give an instruction to write data, a source address 502 in the host use area 101 at which write target data is stored, a first destination address 503 indicative of an address to which write data is to be written, and the data length 504 of the write data. The first destination address 503 is represented as the LBA.

The host controller main section 122 receives, via the bus adapter 121, the write command 500 transmitted by the CPU 110, and reads the source address 502 and the first destination address 503 both contained in the received write command 500. Then, the host controller main section 122 transfers the data stored at the source address 502 and the first destination address 503 to the memory system 2 via the device connection adapter 126.

The host controller main section 122 may utilize the main memory DMA 123 in reading the data stored at the source address 502. At this time, the host controller main section 122 sets the source address 502 and the data length 504 and the destination address at buffer addresses in the host controller main section 122, and activates the main memory DMA 123.

Furthermore, the host controller main section 122 can receive various commands other than the write command 500 from the CPU 110. Here, the host controller main section 122 enqueues the received command in a command queue and takes processing target commands from the command queue in order starting with the leading command. The area in which the data structure of the command queue is stored may be secured on the main memory 100 or configured by arranging a small-scale memory or register inside or near the host controller main section 122.

Additionally, the communication path between the host controller main section 122 and each of the main memory DMA 123, the control DMA 124, and the data DMA 125 is not limited to a particular path. For example, the bus adaptor 121 may be used as a communication path or a dedicated line may be provided and used as a communication path.

<Command Format>

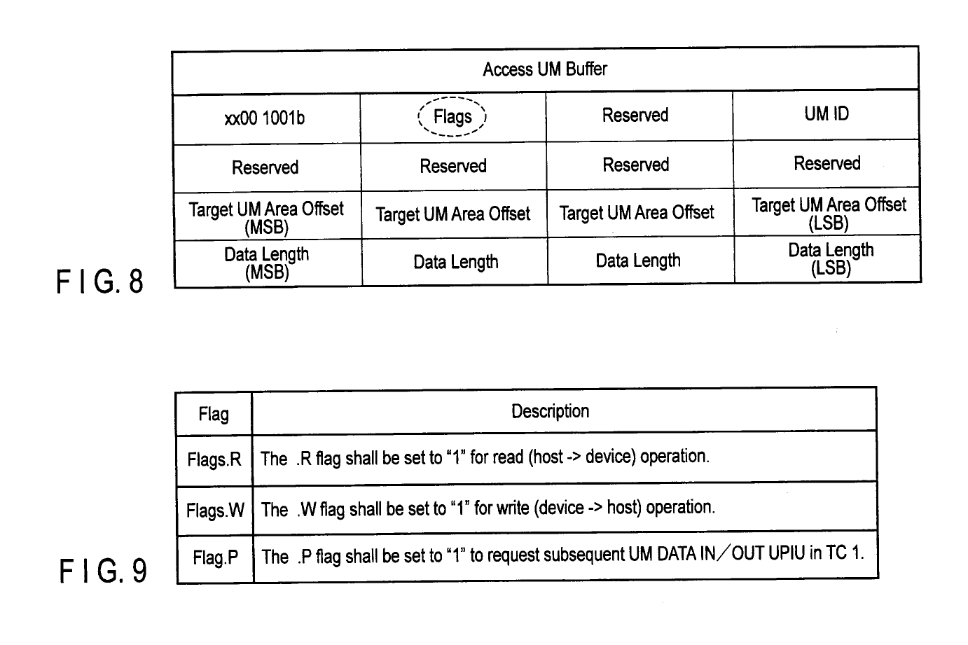

Now, the format of a data transfer command (also referred to as a request) according to the present embodiment will be described with reference to FIG. 8. FIG. 8 is a diagram showing an example of the format of the data transfer command according to the present embodiment.

As shown in FIG. 8, the data transfer command (Access UM Buffer) may contain various pieces of information when used to make a data transfer request to the host device 1. The data transfer command (Access UM Buffer) according to the present embodiment may specifically contain flag information (see dashed part of FIG. 8).

<Flags>

Now, with reference to FIG. 9, the flags contained in the data transfer command (Access UM Buffer) according to the present embodiment will be described. FIG. 9 shows an example of the flags contained in the data transfer command (Access UM Buffer) according to the present embodiment.

As shown in FIG. 9, the data transfer command (Access UM Buffer) according to the present embodiment contains three types of flag: R, W and P. Upon receiving a command from the host device 1, the memory system 2 sets these flags in the data transfer command.

[Flag R]

Flag R indicates that the subsequent operation reads data from the main memory 100 of the host device 1 into the memory system 2.

Specifically, if the subsequent operation reads data from the host device 1 into the memory system 2, flag R is set.

[Flag W]

Flag W indicates that the subsequent operation writes data from the memory system 2 into the main memory 100 of the host device 1.

If the subsequent operation writes data from memory system 2 to the host device 1, flag W is set.

[Flag P]

Flag P determines the priority of the subsequent data input sequence (UM DATA IN) from the memory system 2 to the host device 1 or the subsequent output sequence (UM DATA OUT) from the host device 1 to the memory system 2. Each sequence is carried out via the port corresponding to the selected priority.

Specifically, flag P is set if the priority of the data input sequence (UM DATA IN) from the memory system 2 to the host device 1 or the output sequence (UM DATA OUT) from the host device 1 to the memory system 2 is high. Upon recognizing that flag P is set, the host device 1 transmits and receives data via the second port set to priority 1 (high).

Flag P is cleared if the priority of the data input sequence (UM DATA IN) from the memory system 2 to the host device 1 or the output sequence (UM DATA OUT) from the host device 1 to the memory system 2 is low. Thus, upon recognizing that flag P has been cleared, the host device 1 transmits and receives data via the third port with priority 0 (low).

<Read Operation>

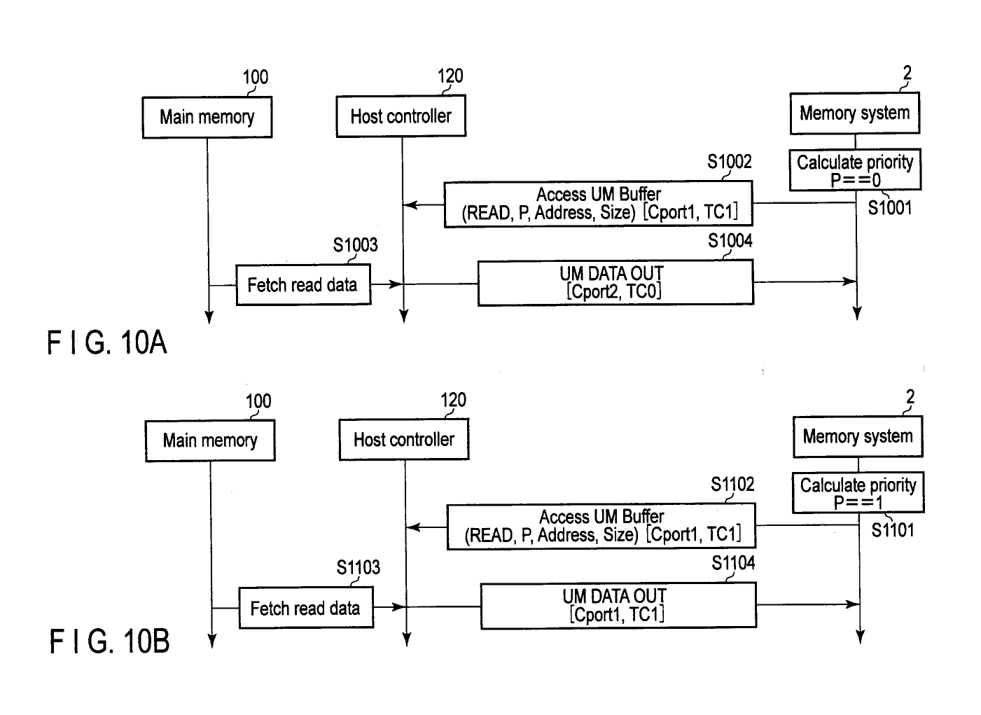

Now, an example of operations performed by the information processing device if the memory system 2 reads data from the host device 1 will be described with reference to FIG. 10. FIG. 10A is a diagram showing an operation in which the memory system 2 receives data via the third port. FIG. 10B is a diagram showing an operation in which the memory system 2 receives data via the second port.

First, an operation performed in the following case will be described: the information processing device includes two priority settings (0, low priority; 1, high priority) for the communication path 3, and when a data transfer is requested, the priority of the communication path 3 used for the corresponding data transfer is constantly maintained at 0, as shown in FIG. 10A.

[Step S1001]

The device controller main section 202 determines that priority 0 is to be used when receiving data from the host device 1. Thus, the device controller main section 202 clears flag P in the data transfer command (Access UM Buffer). Furthermore, the device controller main section 202 is to read data from the host device 1, and thus sets flag R in the data transfer command (Access UM Buffer).

[Step S1002]

The device controller main section 202 transmits a command (Access UM Buffer) to read data stored in the device use area 102 and including information such as: flag R, set; flag P, clear; address; and size (READ; P==0; Address; Size). The command is transmitted to the host device 1 via the second port with priority 1 (high) (CPort 1; TC 1).

[Step S1003]

Upon receiving, from the memory system 2, the command to read data, the host controller 120 fetches data from the device use area 102 based on information such as: flag R, set; flag P, clear; address; and size (READ; P==0; Address; Size).

[Step S1004]

Then, based on flag P contained in the command (Access UM Buffer) to read data received from the memory system 2, the host controller 120 transfers read data to the memory system 2 via the third port with priority 0 (CPort 2; TC 0) (UM DATA OUT).

Now, an operation performed in the following case will be described: the information processing device includes two priority settings (0, low priority; 1, high priority) for the communication path 3, and when a data transfer is requested, the priority of the communication path 3 used for the corresponding data transfer is constantly maintained at 1, as shown in FIG. 10B.

[Step S1101]

The device controller main section 202 determines that priority 1 is to be used when receiving data from the host device 1. Thus, the device controller main section 202 sets flag P in the data transfer command (Access UM Buffer). Furthermore, the device controller main section 202 is to read data from the host device 1, and thus sets flag R in the data transfer command (Access UM Buffer).

[Step S1102]

The device controller main section 202 transmits a command (Access UM Buffer) to read data stored in the device use area 102 and including information such as: flag R, set; flag P, set; address, and size (READ; P==1; Address; Size). The command is transmitted to the host device 1 via the second port with priority 1 (high) (CPort 1; TC 1).

[Step S1103]

Upon receiving, from the memory system 2, the command (Access UM Buffer) to read data, the host controller 120 fetches data from the device use area 102 based on information such as: flag R, set; flag P, set; address, and size (READ; P==1; Address; Size).

[Step S1104]

Then, based on flag P contained in the command (Access UM Buffer) to read data received from the memory system 2, the host controller 120 transfers read data to the memory system 2 via the third port with priority 1 (CPort 1; TC 1) (UM DATA OUT).

<Write Operation>

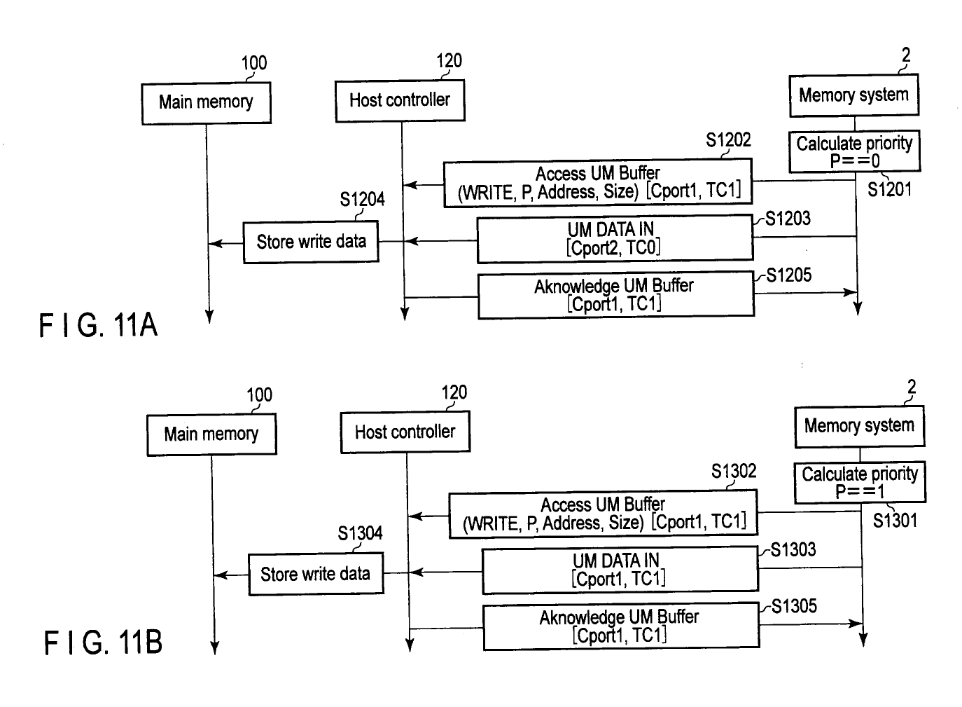

Now, an example of operations performed by the information processing device if the memory system 2 writes data to the host device 1 will be described with reference to FIG. 11. FIG. 11A is a diagram showing an operation in which the memory system 2 transmits data via the third port. FIG. 11B is a diagram showing an operation in which the memory system 2 transmits data via the second port.

First, an operation performed in the following case will be described: the information processing device includes two priority settings for the communication path 3, and when a data transfer is requested, the priority of the communication path 3 used for the corresponding data transfer is constantly maintained at 0, as shown in FIG. 11A.

[Step S1201]

The device controller main section 202 determines that priority 0 is to be used when transmitting data to the host device 1. Thus, the device controller main section 202 clears flag P in the data transfer command (Access UM Buffer) (P==0). Furthermore, the device controller main section 202 is to write data to the host device 1, and thus sets flag R in the data transfer command (Access UM Buffer).

[Step S1202]

The device controller main section 202 transmits a request command (Access UM Buffer) to read data stored in the device use area 102 and including information such as: flag W, set; flag P, clear; address; and size (WRITE, P==0, Address, Size). The command is transmitted to the host device 1 via the second port with priority 1 (CPort 1; TC 1).

[Step 1203]

The device controller main section 202 transmits a command (UM DATA IN) to transmit write data to the host device 1 via the third port with the priority 0 (CPort 2, TC 0).

Upon receiving, from the memory system 2, the command (Access UM Buffer) to write data, the host controller 120 receives the write data from the memory system 2 (UM DATA IN) based on information such as “flag W, set; flag P, clear; address, and size (WRITE, P==0, Address, Size)”. At this time, the host controller 120 receives the write data from the memory system 2 via the third port with the priority 0 (CPort 2; TC 0), based on the flag P contained in the command (Access UM Buffer) to write data received from the memory system 2.

[Step S1204]

The host controller 120 stores the write data received from the memory system 2 in the device use area 102.

[Step S1205]

When the write data is stored in the device use area 102, the host controller 120 transmits a notification command (Acknowledge UM Buffer) meaning that the storage has been completed, to the memory system 2 via the second port with the priority 1 (CPort 1; TC 1). This completes the write of data from the memory system 2 to the host device 1.

Now, an operation performed in the following case will be described: the information processing device includes two priority settings for the communication path 3, and when a data transfer is requested, the priority of the communication path 3 used for the corresponding data transfer is constantly maintained at 1, as shown in FIG. 11B.

[Step S1301]

The device controller main section 202 determines that the priority 1 is to be used when transmitting data to the host device 1. Thus, the device controller main section 202 sets flag P in the data transfer command (Access UM Buffer) (P==1). Furthermore, the device controller main section 202 is to write data to the host device 1, and thus sets flag W in the data transfer command (Access UM Buffer).

[Step S1302]

The device controller main section 202 transmits a command (Access UM Buffer) to write data received from the memory system 2 and including information such as: flag W, set; flag P, set; address, and size (WRITE, P==1, Address, Size), to the host device 1 via the second port with the priority 1 (CPort 1; TC 1).

[Step 1303]

The device controller main section 202 transmits a command (UM DATA IN) to transmit write data to the host device 1 via the third port with the priority 1 (CPort 1; TC 1).

Upon receiving, from the memory system 2, the command (Access UM Buffer) to write data, the host controller 120 receives the write data from the memory system 2 (UM DATA IN) based on information such as: flag W, set; flag P, set; address, and size (WRITE, P==1, Address, Size). At this time, the host controller 120 receives the write data from the memory system 2 via the second port with the priority 1 (CPort 1; TC 1), based on the flag P contained in the command (Access UM Buffer) to write the data received from the memory system 2.

[Step S1304]

The host controller 120 stores the write data received from the memory system 2 in the device use area 102.

[Step S1305]

When the write data is stored in the device use area 102, the host controller 120 transmits a notification command (Acknowledge UM Buffer) meaning that the storage has been completed, to the memory system 2 via the second port with the priority 1 (CPort 1; TC 1). This completes the write of data from the memory system 2 to the host device 1.

Furthermore, the above-described operations (read operation and write operation) of the memory system 2 may be performed if the memory system 2 receives the write command 500 from the host device 1 or may be actively performed by the memory system 2.

<Advantageous Effects of the Memory System According to the First Embodiment>

According to the first embodiment, the information processing device includes the host device 1, the semiconductor memory device 2 with the non-volatile semiconductor memory 210, and the communication path 3 which connects the host device 1 and the semiconductor memory device 2 together. The host device 1 includes the first storage section 100 and the first control section 120 to which the first storage section 100 and the communication path 3 are connected and which controls the first storage section. The communication path 3 includes the plurality of ports to each of which the priority is assigned. The semiconductor memory device 2 includes the second control section 200 connected to the communication path 3 to transmit, to the first control section 120, data including the first flag (flag P) which determines the priority based on the preferential order of the operation of transmitting or receiving data to or from the first storage section 100. Furthermore, upon receiving the data transfer first command, the first control section 120 carries out transmission and reception between the first storage section 100 and the second control section 200 via the port corresponding to the priority, based on the first flag contained in the first command. Furthermore, the priority includes the first priority 0 and the second priority 1, which is lower than the first priority 0. The second control section 200 includes, in the first command, the second flag (flag R) indicating that the subsequent operation reads data from the first storage section 100 or the third flag (flag W) indicating that the subsequent operation writes data to the first storage section 100.

The memory system 2 according to the first embodiment can control the priority when transmitting and receiving data to and from the host device 1.

Commands for data transfer conventionally have no mechanism for controlling the priority. This precludes the priority from being selected as appropriate regardless of the type, size, or the like of data when the data is transmitted or received.

As described above, the priority specifies the preferential order of processing. Specifically, when the host device 1 is packed with a plurality of requests contending against one another, for example, a process with a high priority is carried out earlier than a process with a low priority.

As described above, the memory system 2 according to the first embodiment can include, in a request for data transfer itself, various pieces of flag information including information indicative of the priority of the data transfer. Examples of the flags include the flag R meaning that the subsequent operation reads data from the host device 1, the flag W meaning that the subsequent operation writes data to the host device 1, and the flag P indicative of the priority of the subsequent sequence.

In particular, the flag P included in the request itself allows the priority of the subsequent data in/out to be determined at the stage of the request made to the host device 1. The ability of the memory system 2 to control the priority as appropriate allows the performance of the memory system 2 as a whole to be optimized.

### Second Embodiment

Now, the operation of a memory system according to a second embodiment will be described. The basic configuration and operation of the memory system according to the second embodiment are similar to the basic configuration and operation of the above-described memory system according to the first embodiment. Thus, description of the matters described above in the first embodiment and matters easily conceivable from the first embodiment is omitted.

<Operation of the Device Controller Main Section>

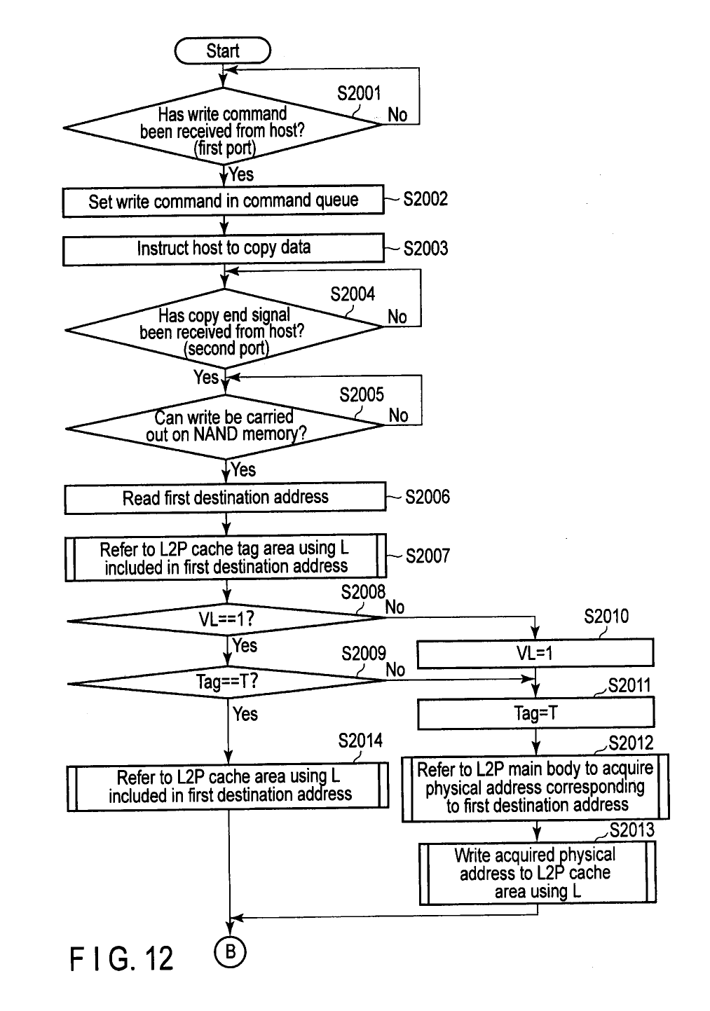

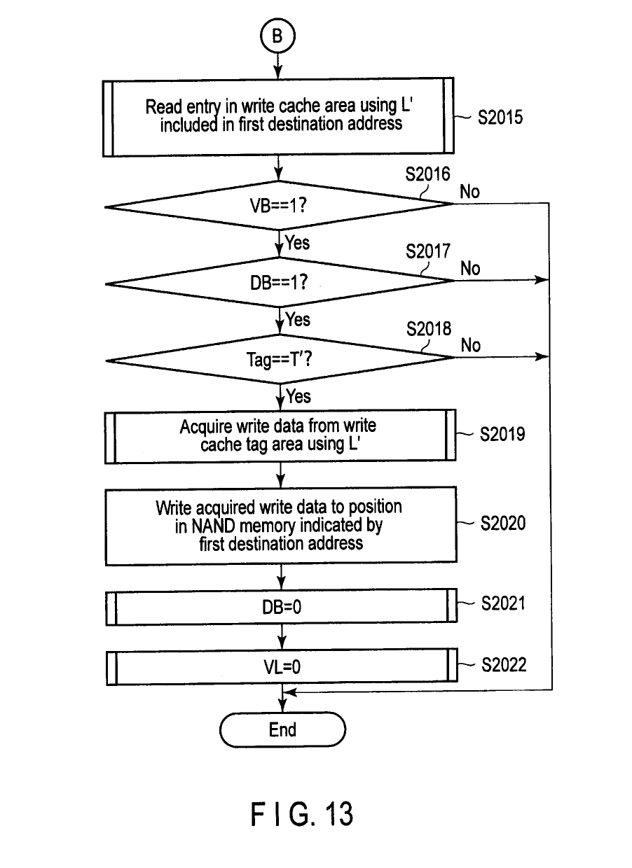

Now, the operation of the device controller main section 202 of the memory system 2 will be described. FIG. 12 and FIG. 13 are flowcharts illustrating the operation of the device controller main section 202.

[Step S2001]

First, the device controller main section 202 waits to receive the write command 500 from the host device 1 via the first port.

[Step S2002]

Upon receiving the write command 500 from the host device 1, the device controller main section 202 stores the received write command 500 in the command queue. The command queue in step S2002 means a command queue for the memory system 2 provided in the RAM 203.

[Step S2003]

The device controller main section 202 instructs the host device 1 to copy data.

More specifically, the host controller main section 122 reads data from an address indicated by the source address 502 in the host use area 101. Then, the host controller main section 122 copies the read data to an address indicated by the second destination address in the device use area 102. The main memory DMA 123 notifies, by a copy end interruption, the host controller main section 122 of a completed DMA transfer.

When the DMA transfer by the main memory DMA 123 is completed, the host controller main section 122 instructs the control DMA 124 to transmit a copy end signal to the memory system 2.

[Step S2004]

The device controller main section 202 waits to receive the copy end signal from the host device 1 via the second port. Upon receiving the copy end signal, the device controller main section 202 determines whether or not write can be carried out on the NAND memory 210.

[Step S2005]

The state in which write can be carried out on the NAND memory 210 means that a ready/busy signal for the NAND memory 210 is indicative of a ready status and that the received write command 500 is at the head of the command queue. If no write can be carried out on the NAND memory 210, the device controller main section 202 executes the determination process in step S2005.

[Step S2006]

If write can be carried out on the NAND memory 210, the device controller main section 202 reads the first destination address 503 contained in the write command 500.

[Step S2007]

The device controller main section 202 then refers to the L2P cache tag area 310 using the value L of the lower 22 bits of the read first destination address 503.

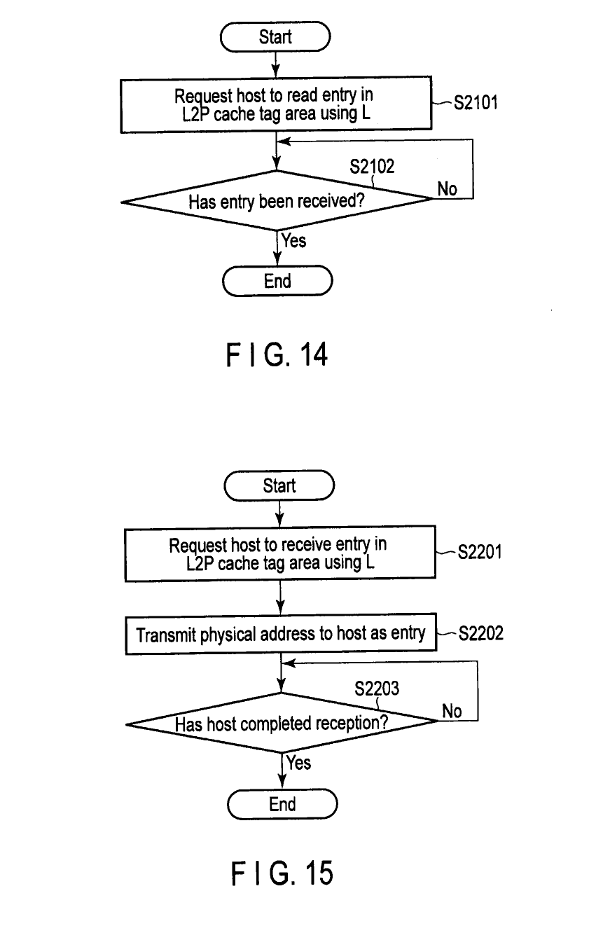

Now, with reference to FIG. 14, step S2007 will be described in further detail. FIG. 14 is a flowchart illustrating a portion of the process in step S2007 in which the device controller main section 202 refers to the L2P cache tag area 310.

[Step S2101]

The device controller main section 202 transmits a request to read an entry (L2P Management Entry) in the L2P cache tag area 310 using L, to the host device 1 via the second port.

More specifically, the device controller main section 202 determines the type of an entry for system control. When an entry for system control (L2P Management Entry) is to be received from the host device 1, the device controller main section 202 determines the priority to be 1 (high). Thus, the device controller main section 202 sets flag P in the data transfer command (Access UM Buffer). Furthermore, the device controller main section 202 is to read the entry (L2P Management Entry) from the host device 1 and thus sets flag R in the data transfer command (Access UM Buffer).

The device controller main section 202 transmits a command (Access UM Buffer) to read data stored in the L2P cache tag area 310 and including information such as; flag R, set; flag P, set; address, and size (READ, P==1, L2PTagBaseAddr, Size), to the host device 1 via the second port with the priority 1 (high) (CPort 1; TC 1).

[Step S2102]

The device controller main section 202 waits to receive the entry. Upon receiving, from the memory system 2, the command (Access UM Buffer) to read data, the host controller 120 fetches the entry (L2P Management Entry) from the L2P cache tag area 310 based on information such as; flag R, set; flag P, set; address, and size (READ, P==1, L2PTagBaseAddr, Size).

Then, the host controller 120 transfers the read entry (L2P Management Entry) to the memory system 2 via the second port with the priority 1 (CPort 1; TC 1) (UM DATA OUT) based on the flag P contained in the command (Access UM Buffer) to read data received from the memory system 2.

The device controller main section 202 receives the entry via the second port. Upon receiving the entry, the device controller main section 202 ends the process in step S2007.

[Step S2008]

Subsequently to the process in step S2007, the device controller main section 202 determines whether or not the VL bit contained in the entry obtained by the process in step S2007 is 1.

[Step S2009]

If the VL bit is 1, the device controller main section 202 determines whether or not the tag information contained in the entry matches the value T of the upper 4 bits of the first destination address 503.

[Step S2010]

If the determination in step S2008 indicates that the VL bit is 0, the device controller main section 202 sets the VL bit of the entry to 1.

[Step S2011]

If in the determination in step S2009, the tag information contained in the entry fails to match the value T of the upper 4 bits of the first destination address 503 or if in step S2010, the VL bit of the entry is set to 1, the device controller main section 202 sets the tag information to T.

[Step S2012]

Subsequently, the device controller main section 202 refers to the L2P main body 211 to acquire a physical address corresponding to the first destination address 503.

[Step S2013]

Then, the device controller main section 202 uses L to write the physical address acquired in step S2012 to the corresponding cache line in the L2P cache area 300.

Now, step S2013 will be described in further detail with reference to FIG. 15. FIG. 15 is a flowchart illustrating a portion of the process in step S2013 in which the device controller main section 202 writes the physical address to the L2P cache area 300.

[Step S2201]

First, the device controller main section 202 requests the host device 1 to receive an entry (L2P Table Cache Entry) in the L2P cache area 300 using L.

More specifically, the device controller main section 202 determines the type of the entry to be transmitted to the host device 1. When an entry for system control (L2P Table Cache Entry) is to be transmitted to the host device 1, the device controller main section 202 determines the priority to be 1 (high). Thus, the device controller main section 202 sets flag P in the data transfer command (Access UM Buffer). Furthermore, the device controller main section 202 is to write the entry (L2P Table Cache Entry) to the host device 1 and thus sets flag W in the data transfer command (Access UM Buffer).

[Step S2202]

The device controller main section 202 transmits the physical address acquired in step S2012 to the host device 1 as a transmission target entry (L2P Table Cache Entry).

More specifically, upon receiving the command (Access UM Buffer) to write data, the host controller 120 receives write data from the memory system 2 (UM DATA IN) based on information such as; flag W, set; flag P, clear; address, and size (WRITE, P==0, Address, Size). At this time, based on the flag P contained in the command (Access UM Buffer) to write data received from the memory system 2, the host controller 120 receives the write data from the memory system 2 via the third port with the priority 0 (CPort 2; TC 0).

Then, the host controller 120 stores the write data received from the memory system 2 in the device use area 102.

[Step S2203]

Then, the device controller main section 202 waits for the host device 1 to complete the reception. When the host device 1 completes the reception, the device controller main section 202 ends the process in step S2013.

The device controller main section 202 can receive, via the second port, a transmitted request, status information indicative of whether or not the host device 1 is ready to receive an entry, and status information indicative of whether or not the host device 1 has completed the reception. Furthermore, the entry can be transmitted to the host device 1 via the third port.

[Step S2014]

If the tag information in the entry read by the process in step S2007 is equal to T, the device controller main section 202 acquires the entry (L2P Table Cache Entry) from the L2P cache area 300.

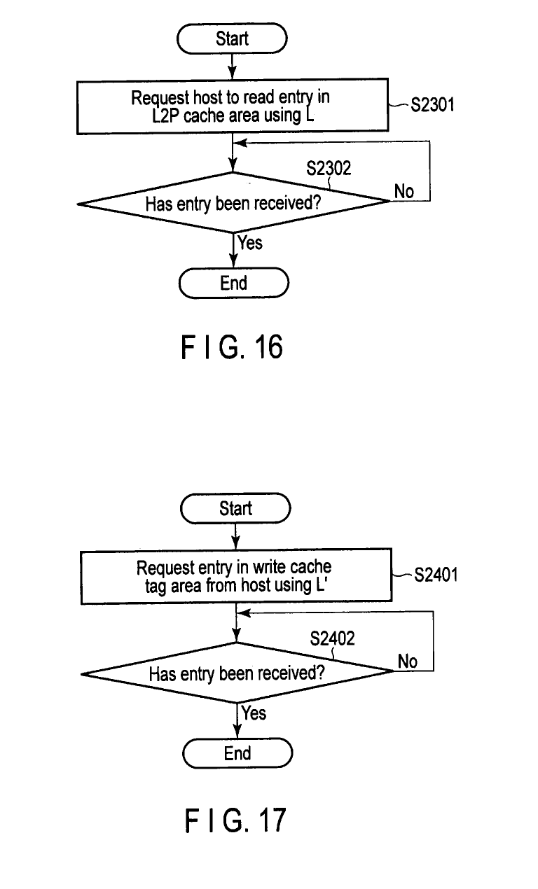

Now, with reference to FIG. 16, step S2014 will be described in further detail. FIG. 16 is a flowchart illustrating a process in which the device controller main section 202 refers to the L2P cache area 300.

[Step S2301]

The device controller main section 202 transmits a request to read an entry (L2P Table Cache Entry) in the L2P cache area 300 using L, to the host device 1 via the second port.

More specifically, the device controller main section 202 determines the type of an entry to be received from the host device 1. When an entry for system control (L2P Table Cache Entry) is to be received from the host device 1, the device controller main section 202 determines the priority to be 1 (high). Thus, the device controller main section 202 sets flag P in the data transfer command (Access UM Buffer). Furthermore, the device controller main section 202 is to read the entry (L2P Table Cache Entry) from the host device 1 and thus sets flag R in the data transfer command (Access UM Buffer).

The device controller main section 202 transmits a command (Access UM Buffer) to read data stored in the L2P cache tag area 310 and including information such as; flag R, set; flag P, set; address, and size (READ, P==1, L2PTagBaseAddr+L, Size), to the host device 1 via the second port with the priority 1 (high) (CPort 1; TC 1).

[Step S2302]

The device controller main section 202 waits to receive the entry. Upon receiving, from the memory system 2, the command (Access UM Buffer) to read data, the host controller 120 fetches the entry (L2P Table Cache Entry) from the L2P cache area 300 based on information such as; flag R, set; flag P, set; address, and size (READ, P==1, L2PTagBaseAddr+L, Size).

Then, the host controller 120 transfers the read entry (L2P Management Entry) to the memory system 2 via the second port with the priority 1 (CPort 1; TC 1) (UM DATA OUT) based on the flag P contained in the command (Access UM Buffer) to read data received from the memory system 2.

The device controller main section 202 receives the entry via the third port. Upon receiving the entry, the device controller main section 202 ends the process in step S2014.

[Step S2015]

Subsequently to the process in step S2013 or step S2014, the device controller main section 202 reads the entry in the write cache tag area 410 using the value L′ of the lower 13 bits of the first destination address 503.

Now, with reference to FIG. 17, step S2015 will be described in further detail. FIG. 17 is a flowchart illustrating a portion of the process in step S2015 in which the device controller main section 202 reads the entry in the write cache tag area 410.

[Step S2401]

The device controller main section 202 requests the entry in the write cache tag area 410 from the host device 1 via the second port 231 using the value L′ of the lower 13 bits of the first destination address 503.

More specifically, the device controller main section 202 determines the type of an entry to be received from the host device 1. When an entry for system control (Buffer Management Entry) is to be received from the host device 1, the device controller main section 202 determines the priority to be 1 (high). Thus, the device controller main section 202 sets flag P in the data transfer command (Access UM Buffer). Furthermore, the device controller main section 202 is to read the entry (Buffer Management Entry) from the host device 1 and thus sets flag R in the data transfer command (Access UM Buffer).

The device controller main section 202 transmits a command (Access UM Buffer) to read data stored in the write cache tag area 410 and including information such as; flag R, set; flag P, set; address, and size (READ, P==1, WCTagBaseAddr, Size), to the host device 1 via the second port with the priority 1 (high) (CPort 1; TC 1).

[Step S2402]

The device controller main section 202 waits to receive the entry. Upon receiving, from the memory system 2, the command (Access UM Buffer) to read data, the host controller 120 fetches the entry (Buffer Management Entry) from the write cache tag area 410 based on information such as; flag R, set; flag P, set; address, and size (READ, P==1, WCTagBaseAddr, Size).

Then, the host controller 120 transfers the read entry (Buffer Management. Entry) to the memory system 2 via the second port with the priority 1 (CPort 1; TC 1) (UM DATA OUT) based on the flag P contained in the command (Access UM Buffer) to read data received from the memory system 2.

The device controller main section 202 receives the entry via the second port. Upon receiving the entry, the device controller main section 202 ends the process in step S2014.

[Step S2016]

Subsequently to the process in step S2014, the device controller main section 202 determines whether or not the VB bit contained in the read entry is 1.

[Step S2017]

If the VB bit is 1, the device controller main section 202 determines whether or not the DB bit contained in the entry is 1.

[Step S2018]

If the DB bit is 1, the device controller main section 202 determines whether or not the tag information contained in the entry matches T′.

If the VB bit is 0, the DB bit is 0, or the tag information fails to match T′, the device controller main section 202 ends its operation.

[Step S2019]

In step S2018, if the tag information contained in the entry matches T′, the device controller main section 202 determines that write target write data is present in the write cache area 400. In this case, the device controller main section 202 uses L′ to acquire the write data from the corresponding cache line in the write cache area 400.

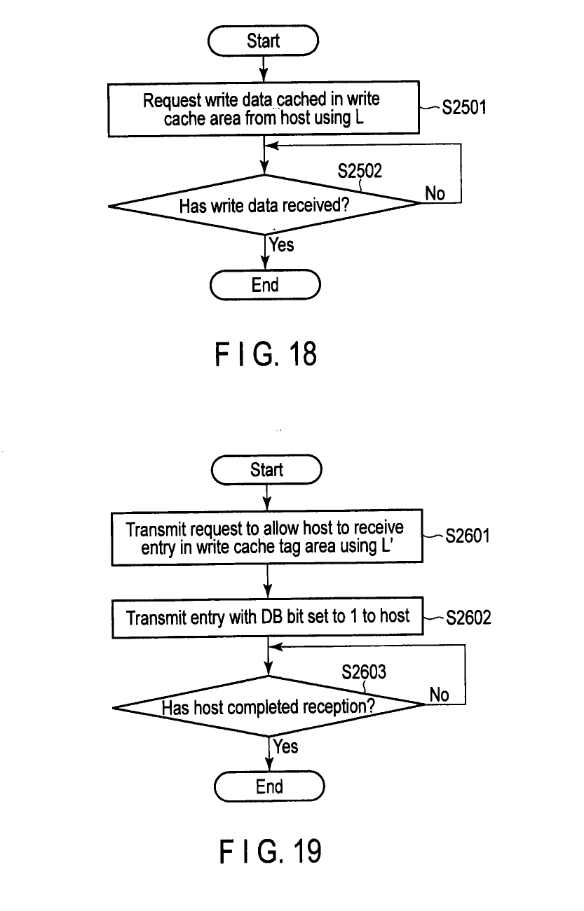

Now, with reference to FIG. 18, step S2019 will be described in further detail. FIG. 18 is a flowchart illustrating a portion of the process in step 2019 in which the device controller main section 202 acquires write data from the host device 1.

[Step S2501]

The device controller main section 202 requests write data cached in the write cache area 400 from the host device 1 via the second port 231 using L′.

More specifically, the device controller main section 202 determines the type of an entry to be received from the host device 1. When an entry which is user data (Write Buffer Entry) is to be received from the host device 1, the device controller main section 202 determines the priority to be “0 (high)”. Thus, the device controller main section 202 sets the flag P in the data transfer command (Access UM Buffer) to 0. Furthermore, the device controller main section 202 is to read the entry (Write Buffer Entry) from the host device 1 and thus sets flag R in the data transfer command (Access UM Buffer).

The device controller main section 202 transmits a command (Access UM Buffer) to read data stored in the write cache area 400 and including information such as; flag R, set; flag P, clear; address, and size (READ, P==0, WCTagBaseAddr+L′ x8K, Size), to the host device 1 via the third port with the priority 0 (low) (CPort 2, TC 0).

[Step S2502]

The device controller main section 202 waits to receive the entry. Upon receiving, from the memory system 2, the command (Access UM Buffer) to read data, the host controller 120 fetches the entry (Write Buffer Entry) from the write cache area 400 based on information such as; flag R, set; flag P, clear; address, and size (READ, WCBaseAddr+L, Size).

Then, the host controller 120 transfers the read entry (Write Buffer Entry) to the memory system 2 via the third port with the priority 0 (CPort 2; TC 0) (UM DATA OUT) based on the flag P contained in the command (Access UM Buffer) to read data received from the memory system 2.

The device controller main section 202 receives the entry via the third port. Upon receiving the entry, the device controller main section 202 ends the process in step S2019.

[Step S2020]

Subsequently to the process in step S2019, the device controller main section 202 writes the acquired write data to a position indicated by the physical address in the NAND memory 210 acquired in step S2013 or step S2014.

[Step S2021]

Then, the device controller main section 202 sets the DB bit of the entry in the write cache tag area 410 referred to by the process in step S2014, to 0.

Now, with reference to FIG. 19, step S2021 will be described in further detail. FIG. 19 is a flowchart illustrating a portion of the process in step 2021 in which the device controller main section 202 manipulates the value of the DB bit.

[Step S2601]

The device controller main section 202 transmits a request to receive the entry in the write cache tag area 410 using L′, to the host device 1 via the second port 231.

[Step S2602]

The device controller main section 202 transmits the entry with the DB bit set to 1 to the host device 1 via the third port 232.

[Step S2603]

Subsequently, the device controller main section 202 monitors the status information received via the second port 231 to wait for the host device 1 to complete the reception.

When the host device 1 completes reception of the entry, the device controller main section 202 ends the operation in step S2021.

[Step S2022]

Subsequently to the process in step S2021, the device controller main section 202 sets the VL bit of the entry in the L2P cache tag area 310 referred to by the process in step S2007, to 0. The device controller main section 202 thus ends its operation.

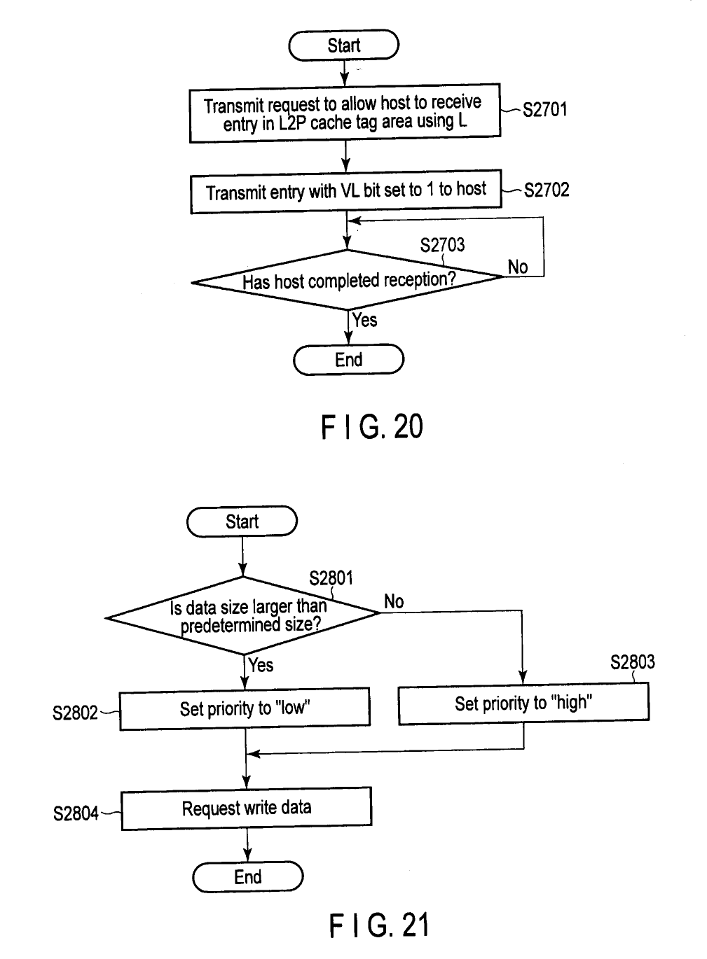

Now, with reference to FIG. 20, step S2022 will be described in further detail. FIG. 20 is a flowchart illustrating a portion of the process in step 2022 in which the device controller main section 202 manipulates the VL bit value.

[Step S2701]

The device controller main section 202 transmits a request to receive the entry in the L2P cache tag area 310 using L, to the host device 1 via the second port 231.

[Step S2702]

The device controller main section 202 transmits the entry with the VL bit set to 1 to the host device 1 via the third port 232.

[Step S2703]

Subsequently, the device controller main section 202 monitors the status information received via the second port 231 to wait for the host device 1 to complete the reception.

When the host device 1 completes reception of the entry, the device controller main section 202 ends the operation in step S2022.

<Advantageous Effects of the Information Processing Device According to the Second Embodiment>

As described above, the device controller main section 202 according to the second embodiment defines the priority used when receiving an entry for system control (L2P Management Entry, L2P Table Cache Entry, or Buffer Management Entry) from the host device 1, as the priority 1 (high). The device controller main section 202 also defines the priority used when receiving, from the host device 1, an entry which is user data (Write Buffer Entry), as the priority 0 (low).

In the description of the first embodiment, the priority of the communication path 3 is defined to be constantly 0 or to be constantly 1. However, the performance of the information processing device as a whole can be optimized by changing the priorities of the data transfer for system control and the transfer of user data in the memory system 2 according to the second embodiment.

### Third Embodiment

Now, the operation of the memory system according to the third embodiment will be described. The second embodiment has been described in conjunction with the case where the memory system 2 determines the priority of the communication path 3 used for data transfer, depending on the type of data. The third embodiment will be described in conjunction with a case where the memory system 2 determines the priority based on the size of data. The basic configuration and operation of the memory system according to the third embodiment are similar to the basic configurations and operations of the above-described memory systems according to the first and second embodiments. Thus, description of the matters described above in the first and second embodiment and matters easily conceivable from the first and second embodiments is omitted.

With reference to FIG. 21, another example of the operation in step S2501 shown in FIG. 18 will be described. FIG. 21 is a flowchart illustrating a process in which the device controller main section determines the priority.

[Step S2801]

When receiving, from the host device 1, an entry which is user data, the device controller main section 202 determines the size of the data.

[Step S2802]

Upon determining, in step S2801, that the size of the data is larger than a predetermined size, the device controller main section 202 sets the priority used when receiving, from the host device 1, the entry which is user data (Write Buffer Entry), to 0 (low).

[Step S2803]

Upon determining, in step S2801, that the size of the data is smaller than the predetermined size, the device controller main section 202 sets the priority used when receiving, from the host device 1, the entry which is user data (Write Buffer Entry), to 1 (high).

[Step S2804]

The device controller main section 202 sets the flag P set in step S2802 or step S2803, in the data transfer command (Access UM Buffer).

Moreover, the device controller main section 202 is to read the entry (Write Buffer Entry) from the host device 1 and thus sets flag R in the data transfer command (Access UM Buffer).

The device controller main section 202 transmits the command (Access UM Buffer) to read data stored in the write cache area 400 and including information such as; flag R, set; flag P, address, and size (READ, P, WCTagBaseAddr+L′ x8K, Size), to the host device 1 via the second port with the priority 1 (high) (CPort 1; TC 1).

According to the above-described third embodiment, the device controller main section 202 sets the priority to 0 (low) when transmitting or receiving data of at least the predetermined size. The device controller main section 202 sets the priority to 1 (high) when transmitting or receiving data of a size smaller than the predetermined size.

However, this configuration is only illustrative. The device controller main section 202 may set the priority to 1 (high) when transmitting or receiving data of at least the predetermined size and may set the priority to 0 (low) when transmitting or receiving data of a size smaller than the predetermined size.

As described above, the device controller main section 202 can switch the priority (0: low priority, 1: high priority) as appropriate, for example, based on the size of data to be transmitted or received. Thus, the third embodiment can exert effects similar to those described in the first and second embodiments.

### Fourth Embodiment

Now, the operation of a memory system according to a fourth embodiment will be described. The third embodiment has been described in conjunction with the case where the memory system 2 determines the priority based on the size of data. The fourth embodiment will be described in conjunction with a case where the host 1 determines the priority. The basic configuration and operation of the memory system according to the fourth embodiment are similar to the basic configurations and operations of the memory systems according to the above-described first to third embodiments. Thus, description of the matters described above in the first to third embodiments and matters easily conceivable from the first to third embodiments is omitted.

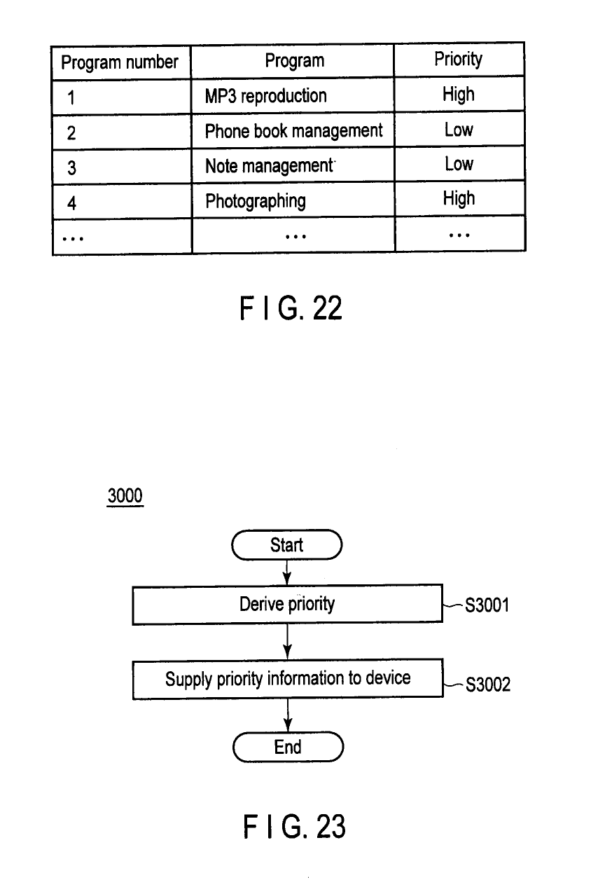

As shown in FIG. 22, for example, the host use area 101 of the host device 1 holds a table which defines the relations between program numbers, program types, or the like and priorities. The table is only illustrative, and the present embodiment is not limited to this. For example, the table may define the relations between the names or IDs of the programs and the priorities. With reference to the table, the CPU 110 can derive the priority based on the name, ID, or type of a program to be processed by the CPU 110.

Now, with reference to FIG. 23, an operation 3000 in which the host device 1 determines the priority will be described.

[Step S3001]

The CPU 110 acquires the priority corresponding to the program to be processed by the CPU 110. More specifically, as described above, the CPU 110 can acquire the priority corresponding to the name, ID, type, or the like of the program to be processed by the CPU 110 by referencing the table held in the host use area 101 shown in FIG. 22.

[Step S3002]

The host controller main section 122 supplies the priority read by the CPU 110 to the memory system 2 as priority information. Thus, upon receiving the priority information from the host controller main section 122, the device controller main section 202 sets the flag P in the data transfer command (Access UM Buffer) based on the priority information. Then, for example, the device controller main section 202 does not change the determined setting of the flag P unless the host controller main section 122 provides new priority information to the device controller main section 202.

The device controller main section 202 transmits the data transfer command (Access UM Buffer) containing at least the “flag P” information to the host device 1 via the second port (CPort 1; TC 1), which operates with the priority 1 (high).

According to the above-described fourth embodiment, the host device 1 determines the priority based on the program to be processed by the host device 1. Thus, the host device 1 can determine the priority.

### Fifth Embodiment

Now, a memory system according to a fifth embodiment will be described. The fourth embodiment has been described in conjunction with the case where the host device 1 determines the priority. The fifth embodiment will be described in conjunction with a case where the priority is determined depending on whether or not a device transferring data in real time is connected to the host device 1. The device transferring data in real time is, in other words, a device for which the host device 1 needs to carry out real-time processing. According to the present embodiment, an example of the device transferring data in real time is a camera. Furthermore, description of the matters described above in the first to fourth embodiments and matters easily conceivable from the first to fourth embodiments is omitted.

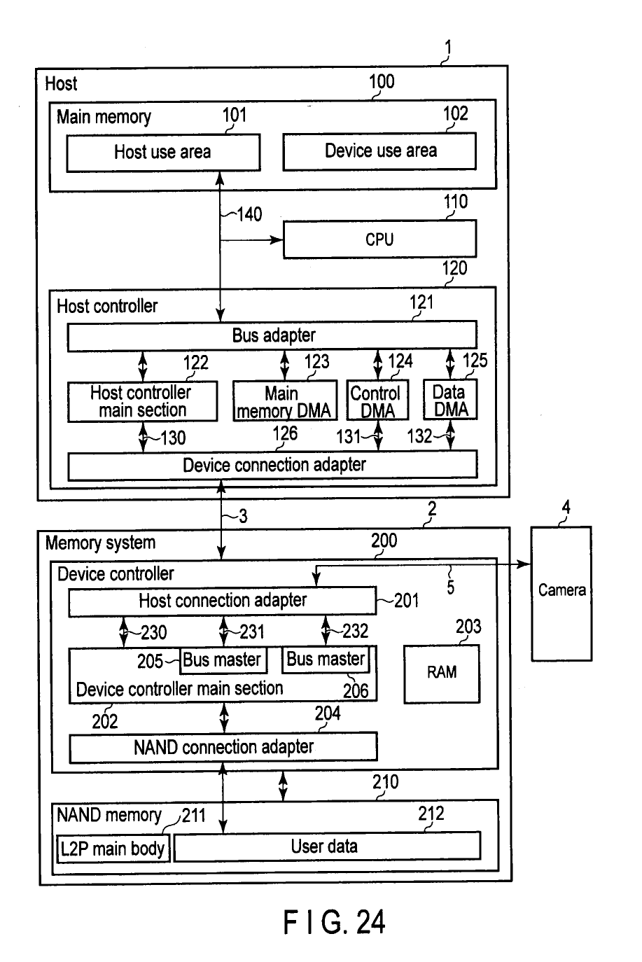

As shown in FIG. 24, in an information processing device according to the fifth embodiment, a camera 4 is connected to the host device 1 via a communication path 5 and the host connection adapter 201 of the memory system 2. Such a connection is also referred to as a daisy chain connection. Here, the daisy chain connection is used to connect the camera 4 to the memory system 2, but the present embodiment is not necessarily limited to this. For example, a star connection may be used to connect the camera 4 to the host device 1.

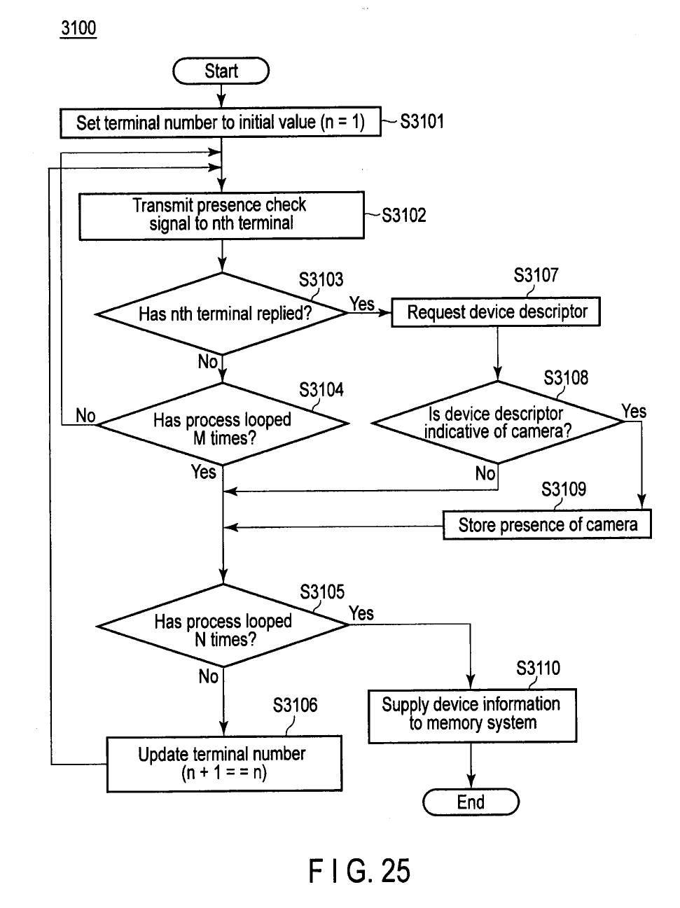

Now, with reference to FIG. 25, an example of an operation in which the host device 1 determines whether or not the camera 4 is connected to the host device 1 will be described. FIG. 25 is a flowchart illustrating an operation 3100 in which the host device 1 determines whether or not the camera 4 has been connected to the host device 1.

The CPU 110 carries out a process (device check operation) 3100 for checking the devices connected to the host device 1. The host device 1 includes N (an integer of at least 1) device connection terminals. In other words, up to N devices can be connected to the host device 1. The CPU 110 sequentially checks the 1 to N terminals to determine what devices are connected to which terminals.

[Step S3101]

First, in order to perform a check operation of checking what device is connected to a terminal n, the CPU 110 sets initial value (n:=1) to n, so that it can select the 1st terminal. The reference character n as used herein is indicative of a terminal number.

[Step S3102]

Then, the CPU 110 transmits a presence check signal to the n-th terminal.

[Step S3103]

Then, the CPU 110 determines whether or not the n-th terminal to which the presence check signal has been transmitted has replied to the presence check signal within a predetermined time.

[Step S3104]

In step S3103, if the CPU 110 determines that the n-th terminal has not replied to the presence check signal even after the elapse of the predetermined time, the CPU 110 determines whether or not steps S3102 and S3103 have been repeated M (an integer of at least 1) times. At this time, if the CPU 110 determines that steps S3102 and S3103 have not been repeated M times, the CPU 110 repeats step S3102.

[Step S3105]

In step S3104, if steps S3102 and S3103 have been repeated M (an integer of at least 1) times, the CPU 110 determines whether or not the “n-th terminal” to which the CPU 110 has transmitted the presence check signal is the “N-th terminal” (n=N).

[Step S3106]

In step S3105, if the CPU 110 determines that the “n-th terminal” to which the CPU 110 has transmitted the presence check signal is not the “N-th terminal”, the CPU 110 adds 1 to the current terminal number “n”, and repeats step S3102 with the new terminal number “n”.

[Step S3107]

In step S3103, if a reply to the presence check signal has been received from the n-th terminal within the predetermined time, the CPU 110 requests the device connected to the n-th terminal having replied to transmit a device descriptor to the CPU 110.

[Step S3108]

The CPU 110 determines whether or not the device descriptor of the device received from the device is indicative of a camera. If the CPU 110 determines that the device descriptor of the device is not indicative of a camera, the CPU 110 shifts to step S3105.

[Step S3109]

In step S3108, if the CPU 110 determines that the device descriptor of the device received from the device is indicative of a camera, the CPU 110 stores device information indicating that the camera 4 is connected to the host device 1 in the host use area 101 of the host device 1. The CPU 110 then shifts to step S3105.

[Step S3110]

In step S3105, if the CPU 110 determines that the “n-th terminal” is the “N-th terminal” (n=N), the CPU 110 transmits the device information stored in the host use area 101 of the host device 1, to the memory system 2. Then, the CPU 110 ends the device check operation 3100.

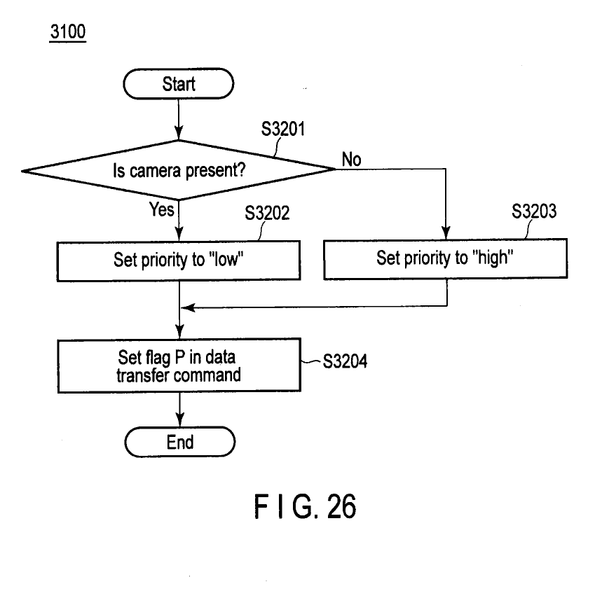

Now, an operation 3200 in which the device controller main section determines the priority will be described with reference to FIG. 26.

[Step S3201]

Upon receiving the device information from the host device 1, the device controller main section 202 determines whether or not the device information is indicative of the camera 4.

[Step S3202]

In step S3201, if the device controller main section 202 determines that the device information is indicative of the camera 4, the device controller main section 202 determines the priority to be “low”, and clears flag P (the priority is low).

[Step S3203]

In step S3201, if the device controller main section 202 determines that the device information is not indicative of the camera 4, the device controller main section 202 determines the priority to be “high”, and sets flag P (the priority is high).

[Step S3204]

The device controller main section 202 sets the flag P set in step S3202 or S3203, in the data transfer command (Access UM Buffer).

The device controller main section 202 transmits the data transfer command (Access UM Buffer) containing at least the “flag P” information to the host device 1 via the second port (CPort 1; TC 1), which operates with the priority 1 (high).

In the above-described fifth embodiment, if the camera 4 is connected to the host device 1, the device controller main section 202 sets the priority to 0 (low). If the camera 4 is not connected to the host device 1, the device controller main section 202 sets the priority to 1 (high).

However, this is only illustrative, and if a device requesting real-time processing is connected to the host device 1, similar processing may be carried out.

### Sixth Embodiment

Now, the operation of a memory system according to a sixth embodiment will be described. The fifth embodiment has been described in conjunction with the case where the priority is determined depending on whether or not a device carrying out real-time processing is connected to the host device 1. The sixth embodiment will be described in conjunction with a case where the priority is determined depending on the communication density of the communication path 3. Description of the matters described above in the first to fifth embodiments and matters easily conceivable from the first to fifth embodiments is omitted.

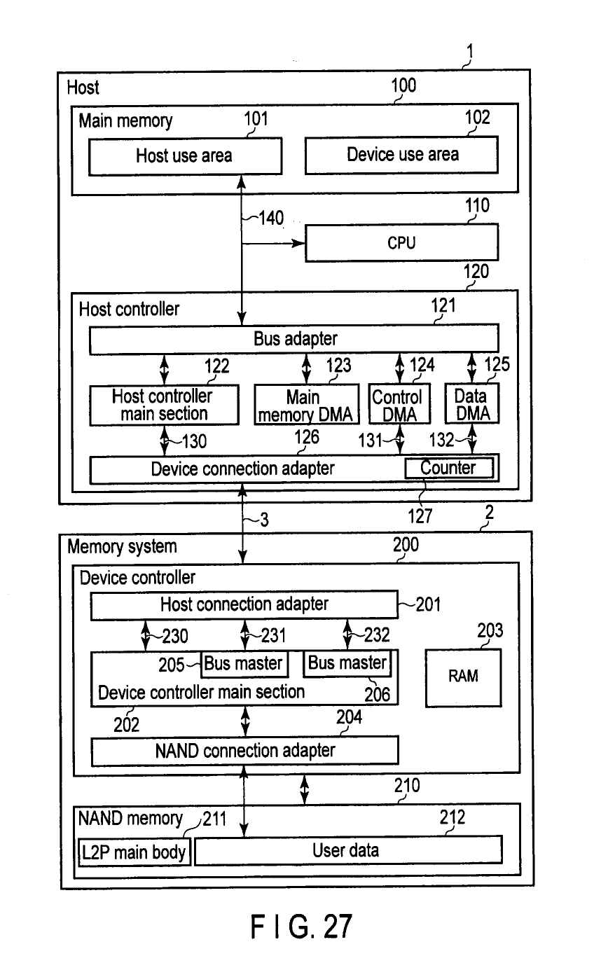

A basic configuration of an information processing device according to the sixth embodiment will be described with reference to FIG. 27. The host device 1 according to the sixth embodiment measures the communication density of the communication path 3. More specifically, for example, a counter 127 is provided in the device connection adapter 126 to measure the communication density, that is, the number of packets transmitted and received on the communication path 3 during a given time (or the total packet size). The counter 127 then supplies the communication density to the device controller main section 202.

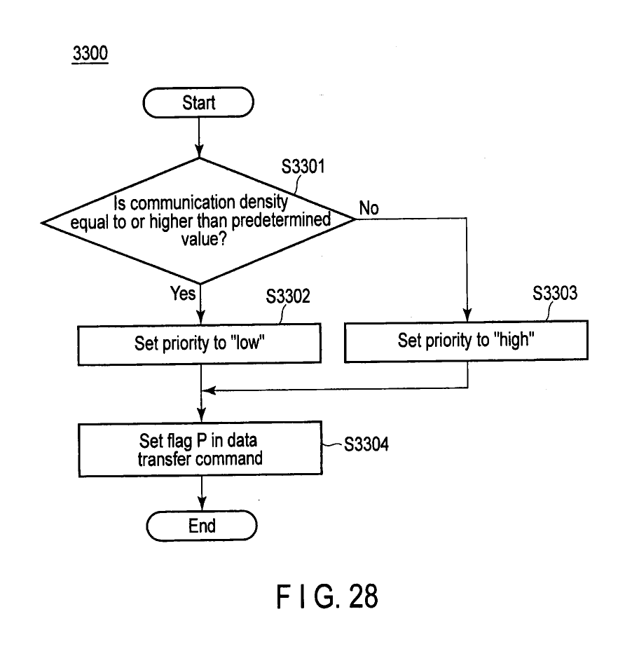

An operation 3300 in which the device controller main section determines the priority will be described with reference to FIG. 28.

[Step S3301]

Upon receiving the communication density of the communication path 3 from the host device 1, the device controller main section 202 determines whether or not the communication density is equal to or higher than a predetermined density T.

[Step S3302]

In step S3301, if the device controller main section 202 determines that the communication density is equal to or higher than the predetermined density T, the device controller main section 202 determines the priority to be “low” and clears flag P (the priority is low).

[Step S3303]

In step S3301, if the device controller main section 202 determines that the communication density is lower than the predetermined density T, the device controller main section 202 determines the priority to be “high” and sets flag P (the priority is high).

[Step S3304]

The device controller main section 202 sets the flag P set in step S3302 or S3303, in the data transfer command (Access UM Buffer).

The device controller main section 202 transmits the data transfer command (Access UM Buffer) containing at least the “flag P” information to the host device 1 via the second port (CPort 1; TC 1), which operates with the priority 1 (high).

According to the above-described sixth embodiment, if the communication density of the communication path 3 is equal to or higher than the predetermined density, the device controller main section 202 sets the priority to 0 (low). If the communication density of the communication path 3 is lower than the predetermined density, the device controller main section 202 sets the priority to 1 (high).

According to the sixth embodiment, the counter 127 is provided in the device connection adapter 126 to measure the communication density of the communication path 3. However, the present embodiment is not necessarily limited to this. Any means that can measure the communication density of the communication path 3 is applicable to the present embodiment.

### Modifications

In connection with the operations described in the first embodiment, when a data transfer is requested, the memory system 2 constantly maintains the priority of the communication path 3 which is used for the corresponding data transfer at 0 or 1. However, the device controller main section 202 may switch the priority (0: low priority, 1: high priority) as appropriate based on a predetermined condition.

Furthermore, according to the above-described third embodiment, the memory system 2 determines the priority of the communication path 3 based on the size of data. However, the memory system 2 may determine the priority taking both the type and size of data into consideration as described in the second embodiment.

Additionally, the above-described embodiments may be combined together as appropriate. Specifically, the fifth embodiment and the sixth embodiment may be combined together.

Additionally, the embodiments have been described using the UFS memory device. However, the present invention is not limited to the UFS memory device. Any memory system may be used provided that for example, the memory system is based on a client server model. More specifically, any memory system is applicable provided that the memory system allows such flag information as described above (flag R, flag W, flag P, and the like) to be added to commands.

In addition, the embodiments have been described using the UFS memory device. However, any semiconductor memory device operating similarly to the UFS memory device is also applicable to other memory cards, memory devices, internal memories, or the like and can exert advantageous effects similar to those in the first embodiment and the second embodiment. Additionally, the flash memory 210 is not limited to the NAND flash memory but may be any other semiconductor memory.

While certain embodiments have been described, these embodiments have been presented by way of example only, and are not intended to limit the scope of the inventions. Indeed, the novel embodiments described herein may be embodied in a variety of other forms; furthermore various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing device comprising a host device, a semiconductor memory device with a nonvolatile semiconductor memory, and a communication path connecting the host device and the semiconductor memory device,
wherein the host device comprises:
a first storage section; and
a first control section to which the first storage section and the communication path are connected and which controls the first storage section,
the communication path comprises:
a plurality of ports to each of which a priority is assigned,
the semiconductor memory device comprises:
a second control section to which the communication path is connected to, and configured to transmits a first command containing a first flag that indicates a priority, the first flag being determined based on a type or size of a data that is transmitted or received to and from the first storage section,
upon receiving the first command, the first control section carries out transmission and reception between the first storage section and the second control section via the port assigned a priority corresponding to the priority indicated by the first flag contained in the first command.

2. The device according to claim 1, wherein the first control section generates a second command, and
upon receiving the second command from the first control section, the second control section transmits the first command succeeding the second command to the first control section.

3. The device according to claim 1, wherein the priority includes a first priority and a second priority higher than the first priority.

4. The device according to claim 1, wherein the second control section includes, in the first command, a second flag indicating that a subsequent operation reads data from the first storage section or a third flag indicating that the subsequent operation writes data to the first storage section.

5. An information processing device comprising a host device, a semiconductor memory device with a nonvolatile semiconductor memory, and a communication path connecting the host device and the semiconductor memory device,
wherein the host device comprises:
a first storage section; and
a first control section to which the first storage section and the communication path are connected and which controls the first storage section,
the communication path comprises:
a plurality of ports to each of which a priority is assigned,
the semiconductor memory device comprises:
a second control section to which the communication path is connected to, and configured to transmits a first command containing a first flag that indicates a priority, the first flag being determined based on a first information that is transmitted from the host device,
upon receiving the first command, the first control section carries out transmission and reception between the first storage section and the second control section via the port corresponding to the priority based on the first flag contained in the first command.

6. The device according to claim 5, wherein the priority includes a first priority and a second priority higher than the first priority.

7. The device according to claim 5, wherein the host device determines the priority based on a program to be executed by the host device, and supplies the priority to the second control section as first information.

8. The device according to claim 5, wherein the host device determines the priority based on a type, a name, or an ID of the program to be executed by the host device, and
supplies the priority to the second control section as the first information.

9. The device according to claim 8, wherein the first storage section further comprises a table in which a relation between the priority and the type, name, or ID of the program to be executed by the host device is set, and
with reference to the table, determines the priority based on the type, name, or ID of the program to be executed by the host device.

10. The device according to claim 5, wherein the host device identifies the type of the device connected to the host device, and supplies a result of the identification to the semiconductor memory device as the first information.

11. The device according to claim 10, wherein when the second control section determines, based on the first information, that a device carrying out real-time processing is connected to the host device, the second control section transmits, to the first control section, a first command containing a first flag which determines the priority to be the first priority lower than the second priority.

12. The device according to claim 11, wherein when the device carrying out real-time processing is a camera.

13. The device according to claim 5, wherein the host device measures a communication density of the communication path, and supplies a result of the measurement to the second control section as the first information.

14. The device according to claim 13, wherein the communication density is a number of packets transmitted through the communication path during a predetermined time or a size of each of the packets.

15. The device according to claim 13, wherein when the second control section determines, based on the first information, that the communication density is equal to or higher than a predetermined value, the second control section transmits, to the first control section, a first command containing a first flag which determines the priority to be the first priority lower than the second priority.

16. The device according to claim 13, wherein when the host device further comprises a counter which measures the communication density of the communication path.

17. A memory system comprising a nonvolatile semiconductor memory and being connectable to a host device via a communication path, the memory system comprising:
a second control section to which the communication path is connected to, and configured to transmits a first command containing a first flag that indicates the priority, the first flag being determined based on a type or size of a data that is transmitted or received to and from a first storage section of the host device,
wherein the second control section receives data indicated by the first command via a port assigned a priority corresponding to the priority indicated by the first flag contained in the first command.
